(19) United States
(12) Patent Application Publication
(10) Pub. No.: US 2009/0006962 A1
(43) Pub. Date: Jan. 1, 2009

(54) AUDIO THUMBNAIL

(75) Inventors: Stephen Ives, Swavesey (GB); Stefan Butlin, Cambridge (GB)

Correspondence Address: BARNES & THORNBURG LLP, P.O. BOX 2786, CHICAGO, IL, 60690-2786, US

(73) Assignee: TAPTU LTD., Cambridge (GB)

(21) Appl. No.: 12/147,632

(22) Filed: Jun. 27, 2008

Related U.S. Application Data
(60) Provisional application No. 60/946,726, filed on Jun. 28, 2007.
(60) Provisional application No. 60/946,728, filed on Jun. 28, 2007.
(60) Provisional application No. 60/946,730, filed on Jun. 28, 2007.
(60) Provisional application No. 60/946,729, filed on Jun. 28, 2007.
(60) Provisional application No. 60/946,727, filed on Jun. 28, 2007.
(60) Provisional application No. 60/946,731, filed on Jun. 28, 2007.

(51) Int. Cl. G06F 3/048; G06F 17/30

(52) U.S. Cl. 715/716; 707/3; 707/E17.009

(57) ABSTRACT

A system (29, 39, 59) generates spoiled audio thumbnails representing corresponding audio content items for a user to browse, such that during audio presentation of a given thumbnail the audio presentation is spoiled by a voice over or similar, but still enables recognition of the corresponding audio content item. This can encourage users to access the original item, and avoid the original items being regenerated from the thumbnails, or being enjoyed instead of the original. This is particularly useful where the audio thumbnail has some value itself, such as for use as a ringtone by mobile users. It can be useful for music libraries and search engines.

### RELATED APPLICATIONS

This application claims the benefit of earlier filed provisional application Ser. No. 60/946,726 filed 28 Jun. 2007 entitled “Audio Thumbnail”. This application also relates to five earlier U.S. patent applications, namely Ser. No. 11/189,312 filed 26 Jul. 2005, published as US 2007/00278329, entitled “processing and sending search results over a wireless network to a mobile device”; Ser. No. 11/232,591, filed Sep. 22, 2005, published as US 2007/0067267 entitled “Systems and methods for managing the display of sponsored links together with search results in a search engine system” claiming priority from UK patent application no. GB0519256.2 of Sep. 21, 2005, published as GB2430507; Ser. No. 11/248,073, filed 11 Oct. 2005, published as US 2007/0067304, entitled “Search using changes in prevalence of content items on the web”; Ser. No. 11/289,078, filed 29 Nov. 2005, published as US 2007/0067305 entitled “Display of search results on mobile device browser with background process”; and U.S. Ser. No. 11/369,025, filed 6 Mar. 2006, published as US2007/0208704 entitled “Packaged mobile search results”. This application also relates to provisional applications:

Ser. No. 60/946,728 filed 28 Jun. 2007 entitled “Ranking Search Results Using a Measure of Buzz”,
Ser. No. 60/946,730 filed 28 Jun. 2007 entitled “Social distance search ranking”
Ser. No. 60/946,729 filed 28 Jun. 2007 entitled “Method of Enhancing Availability of Mobile Search Results”,
Ser. No. 60/946,727 filed 28 Jun. 2007 entitled “Managing Mobile Search Results”,
Ser. No. 60/946,731 filed 28 Jun. 2007 entitled “Festive Mobile Search Results”.
The contents of these applications are hereby incorporated by reference in their entirety.

### FIELD OF THE INVENTION

This invention relates to systems for providing audio thumbnails, to search engines, and to methods of providing audio thumbnails, methods of providing search services, and to methods of using search services, and to corresponding computer programs.

### DESCRIPTION OF THE RELATED ART

It is known to provide audio thumbnails in the form of a characteristic extract or summary of features, to enable faster recognition of items of audio content while browsing. This can be provided as part of a computer based music library for example. Such libraries can be browsed by entering a keyword to get a list of search results, or by viewing a contents list for example. European patent application EP 1437738 shows a system for navigating through a large number of audio files, e.g. MP3 files, using brief representatives of the audio content. Before a user selects a music track, he can benefit from hearing a brief representative excerpt, referred to as “audio thumbnail”. An audio thumbnail is of sufficient length to recognize the music, e.g. 5 or 6 seconds. The stored audio files are preprocessed in order to extract some relevant and objective descriptors used to cluster the music tracks into perceptually homogeneous groups. From each cluster a relevant track is selected automatically or manually, or semi-automatically, and from said selected track an audio thumbnail is extracted. Then these audio thumbnails being key phrases are arranged in a tree data structure, or table of contents, that enables the user to navigate without any visual navigation means. The audio thumbnails allow the user to navigate perceptually through the audio database, without having to remember textual elements, like title or artist names.

To search for online accessible audio content items it is known to use search engines. Search engines are known for retrieving a list of addresses of documents on the Web relevant to a search keyword or keywords. Such documents can include audio content items. A search engine is typically a remotely accessible software program which indexes Internet addresses (universal resource locators (“URLs”), usenet, file transfer protocols (“FTPs”), image locations, etc). The list of addresses is typically a list of “hyperlinks” or Internet addresses of information from an index in response to a query. A user query may include a keyword, a list of keywords or a structured query expression, such as Boolean query.

A typical search engine “crawls” the Web by performing a search of the connected computers that store the information and makes a copy of the information in a “web mirror”. This has an index of the keywords in the documents. As any one keyword in the index may be present in hundreds of documents, the index will have for each keyword a list of pointers to these documents, and some way of ranking them by relevance. The documents are ranked by various measures referred to as relevance, usefulness, or value measures. A metasearch engine accepts a search query, sends the query (possibly transformed) to one or more regular search engines, and collects and processes the responses from the regular search engines in order to present a list of documents to the user.

It is known to rank hypertext pages based on intrinsic and extrinsic ranks of the pages based on content and connectivity analysis. Connectivity here means hypertext links to the given page from other pages, called “backlinks” or “inbound links”. These can be weighted by quantity and quality, such as the popularity of the pages having these links. PageRank™ is a static ranking of web pages used as the core of the search engine known by the trademark Google (http://www.google.com).

Search engines for searching the world wide web are well developed for accessing the web from a desktop personal computer (e.g. Google, Yahoo, et al). Mobile devices that are capable of accessing content on the world wide web are being increasingly numerous. Mobile search engines prompt the user for a search term (or terms) and return mobile search results that are currently limited to links to mobile-specific websites and transcoded (automatically adapted) desktop websites. However, mobile web pages designed specifically for the small screen sizes of mobile devices are very few. A mobile web page is defined as a website whose content is rendered using HTML that can be reasonably viewed and navigated within the constrained display and network capabilities of a hand held mobile device or handset.

### SUMMARY

An object of the invention is to provide improved apparatus or methods. Features of some embodiments of the invention can include:

A system for providing audio thumbnails of audio content items, the system having:

a thumbnail generator arranged to generate audio thumbnails representing corresponding ones of the audio content items; and
a presentation part arranged to make the audio thumbnails available to a user to browse, and to enable the user to select a corresponding one of the audio content items, and a spoiler arranged to spoil the audio thumbnails such that during audio presentation of a given thumbnail to a user, the audio presentation is spoiled but still provides a recognisable representation of the corresponding audio content item.

The spoiling is to encourage users to access the original item, and avoid the original items being regenerated from the thumbnails, or being enjoyed instead of the original. This is particularly useful where the audio thumbnail has some value itself, such as for use as a ringtone by mobile users.

Some other embodiments of the invention can include corresponding methods of providing a search service and methods of using a search service.

Any additional features can be added, and any of the additional features can be combined together and combined with any of the above aspects. Other advantages will be apparent to those skilled in the art, especially over other prior art. Numerous variations and modifications can be made without departing from the claims of the present invention. Therefore, it should be clearly understood that the form of the present invention is illustrative only and is not intended to limit the scope of the present invention.

### BRIEF DESCRIPTION OF THE DRAWINGS

How the present invention may be put into effect will now be described by way of example with reference to the appended drawings, in which:

FIG. 1 shows a system according to an embodiment,

FIG. 2 shows operational steps of an embodiment,

FIG. 3 shows user actions according to an embodiment,

FIG. 4 shows steps according to another embodiment,

FIG. 5 shows an overview of a search engine system according to an embodiment,

FIG. 6 shows query server actions, and

FIG. 7 shows an example of web collections.

### DESCRIPTION OF THE PREFERRED EMBODIMENTS

### Definitions

Audio content can encompass voice, music, ring tones, any sound file, and so on or any other content item which is predominantly audio, or where its value derives primarily from the audio part.

An audio thumbnail can encompass a shortened representation such as an extract or a summary or storyline suitable to enable recognition of the corresponding content item or the character of the corresponding content item when browsing a library of such content items. In some cases, the audio thumbnail can be selected and its presentation triggered by clicking a thumbnail image or a title in a web page, in which case such a thumbnail image or title can be regarded as a part of the audio thumbnail. Spoiling of a thumbnail is intended to mean any kind of spoiling to reduce the enjoyment of the item sufficiently to deter its use other than for recognition while browsing.

A corpus is intended to encompass any collection of content items accessible for searching by a computer of a user, or accessible online, such as all or any part of the world wide web, any collection of web pages, any web site or collection of web sites, any database, any collection of data files, audio, image or video files and so on. It can be located anywhere, such as in storage controlled by web servers, in online databases, in a web mirror crawled from the web, in an indexed web collection, in storage associated with an intranet, or local storage in the user's own computing device and so on.

Score can be any kind of score and encompasses for example a count, a weighted count, an average over time, and so on.

Online means accessible by computer over a network and so can encompass accessible via the internet or public telecommunications networks, or via private networks such as corporate intranets.

Content items encompasses web pages, or extracts of web pages, or programs or files such as images, video files, audio files, text files, or parts of or combinations of any of these and so on.

User can encompass human users or services such as meta search services.

Items which are “accessible online” are defined to encompass at least items in pages on websites of the world wide web, items in the deep web (e.g. databases of items accessible by queries through a web page), items available internal company intranets, or any online database including online vendors and marketplaces.

Hyperlinks are intended to encompass hypertext, buttons, softkeys or menus or navigation bars or any displayed indication or audible prompt which can be selected by a user to present different content.

The term “comprising” is used as an open ended term, not to exclude further items as well as those listed.

### Introduction to Embodiments:

It is fairly well established that copyright owners of digital images are more relaxed about the distribution and republication of their images provided these images can reasonably be described as thumbnails. Thumbnail images are much smaller in size than the original and often use a low image compression quality. The thumbnails therefore represent a likeness of the full-quality image but by themselves are not sufficiently valuable to threaten the business of the owner. However, there is no established equivalent a concept for audio content such as music clips except for the occasional use of providing short clips as music previews, but these are typically of good sound quality.

Embodiments of the present invention provide methods to produce audio thumbnails. They can be provided in such a manner as to represent a likeness of their corresponding original content item while being sufficiently low in value to not threaten the business of the owners of the original. Embodiments can involve using any or all of a number of conversion processes on the original audio track, such as: selecting only a clip (subset in time) of the original, converting a stereo (or multiple channel) signal to mono, resampling at a lower sampling rate, re-encoding at a lower bitrate (i.e. using a lower-quality higher-compression encoding of the music samples) and adding a voice-over (or other additional audio content) to the original.

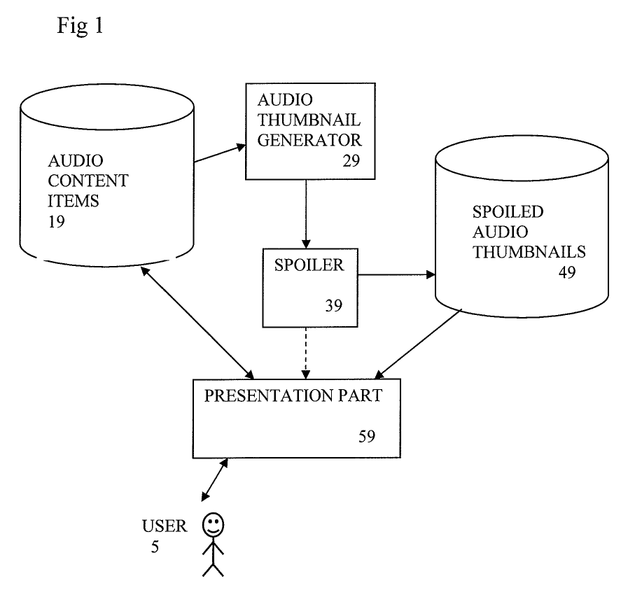

### FIG. 1, Overview of a System According to an Embodiment.

FIG. 1 shows a system according to a first embodiment. A database of audio content items 19 is coupled to an audio thumbnail generator 29. This feeds a spoiler part 39 which either feeds spoiled audio thumbnails to a presentation part 59, or to a database 49 of such spoiled audio thumbnails for later presentation to users. The presentation part has an interface to users 5. The various parts can be integrated together as desired, for example the spoiler can be part of the audio thumbnail generator, but is shown as a separate part for clarity. These parts can be implemented as software functions for execution by conventional computing hardware, implemented in other ways as would be apparent to those skilled in the art. The spoiled thumbnails can be generated on demand, or pre generated, and retrieved on demand, or the thumbnails can be pre generated and then spoiled on retrieval. Any other features can be added and some are set out in dependent claims and some are described in more detail below.

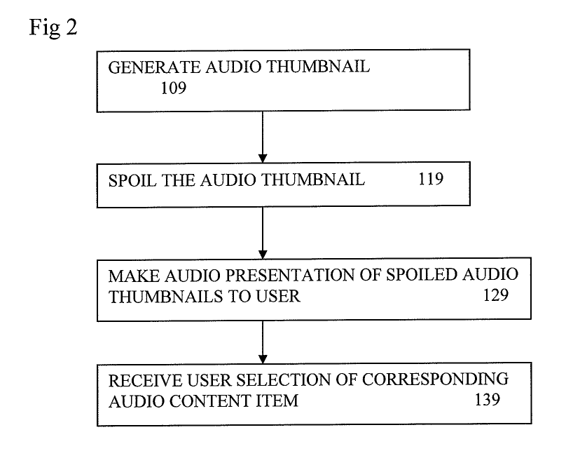

### FIG. 2, Operational Steps of an Embodiment

FIG. 2 shows some operational steps of an embodiment such as the embodiment of FIG. 1 or other embodiments. At step 109, the audio thumbnail is generated. At step 119, it is spoiled, and presented to the user as a spoiled audio presentation at step 129. The user may browse a number of these audio presentations, and at step 139 the system may receive a user selection of a corresponding audio content item represented by one of the audio thumbnails.

### Additional Features of Some Embodiments:

Any features can be added to create further embodiments, some such additional features are set out in dependent claims and some are described in more detail below.

The spoiler can be arranged to add an audible spoiling overlay. This is relatively straightforward, but other ways can be envisaged such as adding disturbing gaps into music. The spoiling overlay can comprise a voice-over. This might be appropriate for spoiling some types of music for example. The spoiling can be a spoiling prefix. This is useful for example in reducing the value of the audio thumbnail as a ringtone, or in other applications sensitive to the start of the audio. The spoiler can be arranged to spoil dynamically in response to a request for the audio thumbnail from the user. The presentation part can be arranged to send a web page to a browser on a device of the user, the web page having hyperlinks to cause the audio presentations of the audio thumbnails when selected by a user. This is useful for accessing online accessible audio content items for example. The web page can be a mobile web page, reasonably viewable on a screen of a hand held mobile device. As some audio thumbnails have particular value as ringtones for mobile web users, it is useful to be able to provide spoiled versions for use in browsing audio content to avoid harming the market in unspoiled versions as ringtones.

The system can comprise a search engine arranged to respond to a search query from the user, the presentation part being arranged to send search results comprising a number of the spoiled audio thumbnails relevant to the search query. This can enable users to browse audio content more easily using the search engine, without needing to pay for unspoiled thumbnails. At least some of the items of audio content can be online accessible, and the web page can have one or more hyperlinks to the online items as well as their corresponding audio thumbnail. This can make it easier for a user to select the online item, either for purchase, or for more information about it for example. The search engine can have a web crawler arranged to crawl online items of audio content, the thumbnail generator being arranged to generate audio thumbnails from the crawled online items. The thumbnail generator can be arranged to pre generate a number of audio thumbnails and store them in a store of audio thumbnails. The search result can be formatted as a portion of a web page, and the user interface be arranged to constrain a size and text format of the mobile web version so that the portion can reasonably be viewed on a screen of a hand held mobile device (in other words is suited to or usable on the screen). It is more convenient for mobile users if the page or an area of text is narrowed so that left or right scrolling is minimized. Text font size may be enlarged to maintain readability. Images may be resized or made into thumbnails which can be expanded by clicking for example. A typical screen size is 4×6 cm or 5×7 cm or 6×9 cm approximately, and often with a “portrait” rather than “landscape” orientation. In other cases the results can be constrained in other ways, to limit usage of bandwidth or processing or memory resources for example.

The indexing part can be arranged to store the audio thumbnail in the form of an unspoiled version and instructions on how to spoil the audio thumbnail on the fly. This can enable a reduction in storage space required, or enable the spoiled version to be up to date, or facilitate on the fly adaptation to a given user device or user preferences for example.

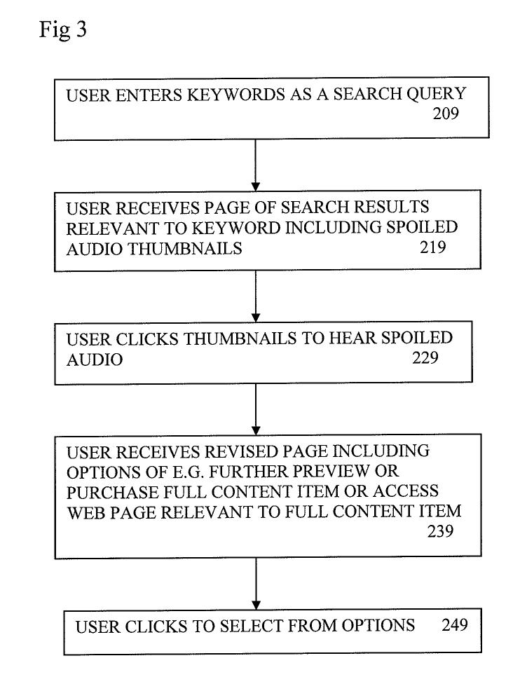

### FIG. 3, Search Engine Embodiment

In some embodiments, a search engine is deployed that includes a searchable database of music tracks. Search results are displayed that offer the user a chance to listen to the audio-thumbnail to determine if the song is the one they were seeking, or is a song that they enjoy. The user in some embodiments is then presented with options to click through to the owner's web site for possible purchase or further preview of the relevant music track.

As shown in FIG. 3, a user enters a keyword or words as a search query at step 209, typically using a web browser. The user receives at step 219 a page of search results relevant to the keywords, and including spoiled audio thumbnails. The user clicks thumbnail hyperlinks or thumbnail images on the web page to start the audio thumbnail playing to hear the spoiled audio.

The audio-thumbnail can be for example a reprocessed version of the original music track, consisting of: the first 30 seconds only, resampling to 22 khz (e.g. from an original of 44 kHz), re-encoding to 48 kbps (e.g. from an original of anything between 96 kps to 312 kbps) and adding a voice over to the first 5 to 10 seconds of the track indicating the song is copyrighted and not for redistribution.

In an alternative embodiment, and one not necessarily limited to a search engine context, the voice-over is any overlaid noise, sound, music or voice(s) that results in the track being unusable other than as a low-quality representation of its original. This might include humorous content which would avoid any frustration the user felt toward the perceived spoiling of the music.

In another embodiment, especially valuable to the context of a search engine, the voice-over could be a spoken advert. In this embodiment, advertisers submit recordings, and the search engine adds the voice over dynamically as a user downloads the preview. Doing this dynamically (rather than preparing it in advance) allows a spoken advert to be chosen that is relevant to the search query used to discover the current search result (that links the music preview). Alternatively, the choice of advert is not search-term sensitive and the voice-over processing can be performed in advance and cached to realise savings in compute resources. In another embodiment, the choice of clip is not limited to the first N seconds, but to a clip customised per song to more appropriately represent that song, e.g. the chorus of a song. This might be identified manually using a team of human operators, or it might be automated using some musical analysis tools. In at least some embodiments of this invention the result is “mobile friendly” (i.e. viewable/consumable on the limited network and display capabilities of a mobile device).

At step 239 the user receives a revised page, depending on which spoiled thumbnails they have listened to, and including further options, such as further previews of selected audio content, other similar items, or a chance to purchase the full audio content item, or access to a web page relevant to the content item. Again the user clicks to select from these options.

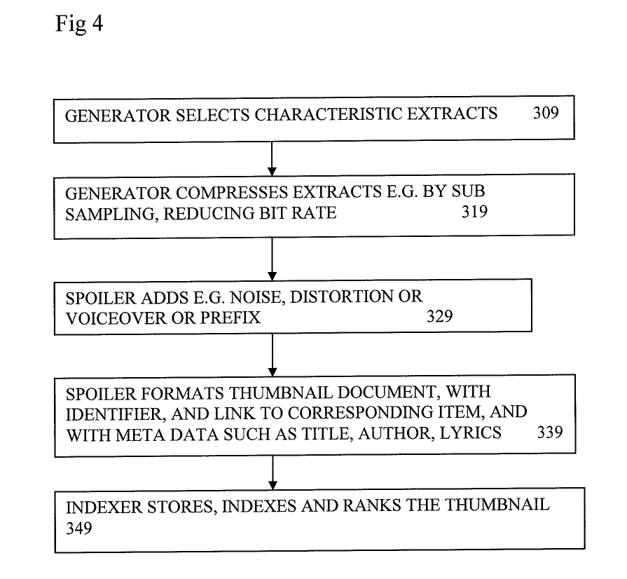

### FIG. 4, Actions of Generator and Spoiler

The audio thumbnail generator selects characteristic extracts of the audio content item at step 309. This can involve manual input if appropriate, or can be partially or fully automated using established techniques. Then at step 319 it compresses the extracts as discussed above, for example by sub sampling or reducing bit rate and so on. At step 329, the spoiler adds noise or distortion or voiceover, depending on the type of audio content being spoiled. This choice can be predetermined manually, or some degree of automation of for example volume control of spoiling can be used. The spoiler can then be used at step 339 to format the resulting thumbnail with an identifier, a link to its corresponding source content item, and meta data such as title, author, lyrics and so on. The thumbnail is then ready to be stored and indexed if desired. Step 349 shows an indexer arranged to index the thumbnail according to keywords which can be taken from the meta data for example, and produce a score for use in ranking the item.

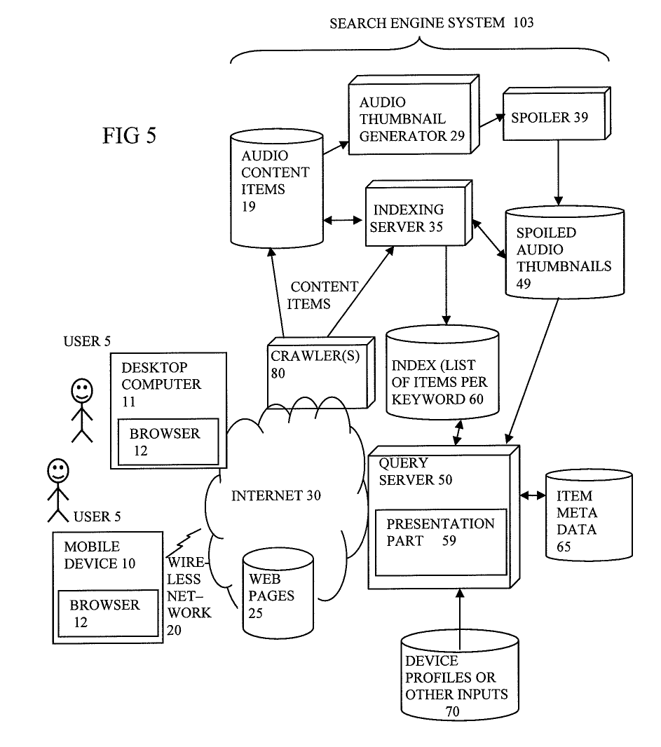

### FIG. 5, Overview of System According to an Embodiment

In some embodiments, a mobile search engine is implemented consisting of the usual components of a search engine: a front end comprising a query server, indexer and indexes, and back-end in the form of crawler components that collect URLs to mobile pages. Examples of suitable components are shown in more detail in the above referenced related applications, particularly:

Packaged Mobile Search Results—U.S. application Ser. No. 11/369,025;
Display Search Results on Mobile Device Browser With Background Process—U.S. application Ser. No. 11/289,078;
Processing and Sending Search Results Over Wireless Network to a Mobile Device—U.S. application Ser. No. 11/189,312.

The front end in the form of the query server provides a mobile friendly interface (i.e. HTML that can be reasonably viewed and navigated on a mobile handset). The back-end in the form of the crawler identifies as many mobile sites and pages as it can find and accumulate over time.

Although described in the context of improving mobile search, some embodiments can also be applied to desktop pages and sites. In this case, the preferred embodiment is as above, except that the crawlers are not limited to mobile web sites and the user interface is a normal HTML front end.

Any of the various features described above can be combined with any other of the features and with other known features. It is particularly useful to combine the features described above with features of mobile searches as described in preceding applications by the present applicants, referenced above.

The overall topology of an embodiment of the invention is illustrated in FIG. 5. This or other topologies can be used to implement the embodiments described above. Some of the features of the embodiment of FIG. 1 are shown in this FIG. 5 using the same reference numerals In FIG. 5, a query server 50 and web crawler 80 are connected to the Internet 30 (and implemented as Web servers—for the purposes of this diagram the web servers are integral to the query and web crawler servers). The web crawler spiders the World Wide Web to access web pages 25 and typically builds up a web mirror database (not shown) of locally-cached web pages. The portion of the web reached, or the web mirror, can be regarded as the corpus. The crawler can control which websites are revisited and how often, to keep up to date with changes in the corpuses. An index server 35 builds an index 60 of the web pages from this web mirror. The crawler can find audio content items to form a database 19 of such content items for use by the audio thumbnail generator. Or the crawler can feed such content items directly to the generator. As in FIG. 1, the generator feeds the spoiler 39, which in turn feeds the database 49 of spoiled audio thumbnails. Alternatively the spoiled audio thumbnails can be generated for the presentation part 59 on demand. The presentation part is shown as a component of the query server. The index server 35 can access the spoiled audio thumbnails to add them to its index 60.

These parts form a search engine system 103. This system can be formed of many servers and databases distributed across a network, or in principle they can be consolidated at a single location or machine. The term search engine can refer to the front end, which is the query server in this case, and some, all or none of the back end parts used by the query server, whose functions can be replaced with calls to external services.

A plurality of users 5 connected to the Internet via desktop computers 11 or mobile devices 10 can make searches via the query server. The users making searches (‘mobile users’) on mobile devices are connected to a wireless network 20 managed by a network operator, which is in turn connected to the Internet via a WAP gateway, IP router or other similar device (not shown explicitly). The search results sent to the users by the query server can be tailored to preferences of the user or to characteristics of their device. Such user preferences or device profiles and any other inputs can be stored in a database 70, coupled to the query server.

Many variations are envisaged, for example the content items can be elsewhere than the world wide web, and the mentions counter or index servers could take content from its source rather than the web mirror and so on. The presentation part of the query server 50 can operate to carry out some of the user interface functions described above,

### Description of Devices

The user can access the search engine from any kind of computing device, including desktop, laptop and hand held computers. Mobile users can use mobile devices such as phone-like handsets communicating over a wireless network, or any kind of wirelessly-connected mobile devices including PDAs, notepads, point-of-sale terminals, laptops etc. Each device typically comprises one or more CPUs, memory, I/O devices such as keypad, keyboard, microphone, touchscreen, a display and a wireless network radio interface.

These devices can typically run web browsers or micro browser applications e.g. Openwave™, Access™, Opera™ browsers, which can access web pages across the Internet. These may be normal HTML web pages, or they may be pages formatted specifically for mobile devices using various subsets and variants of HTML, including cHTML, DHTML, XHTML, XHTML Basic and XHTML Mobile Profile. The browsers allow the users to click on hyperlinks within web pages which contain URLs (uniform resource locators) which direct the browser to retrieve a new web page.

### Description of Servers

There are four main types of server that are envisaged in one embodiment of the search engine according to the invention as shown in FIG. 5, as follows. Although illustrated as separate servers, the same functions can be arranged or divided in different ways to run on different numbers of servers or as different numbers of processes, or be run by different organisations. Hence the use of the term server is not intended to limit to a single processor at a single location, a server can represent a function or functions which are distributed over multiple processors at different locations for example, or multiple servers can be implemented on a single processor.
a) A query server 50 that handles search queries from desktop PCs and mobile devices, passing them onto the other servers, and formats response data into web pages customised to different types of devices, as appropriate. Optionally the query server can operate behind a front end to a search engine of another organization at a remote location. Optionally the query server can carry out ranking of search results, or this can be carried out by a separate ranking server. In principle the functions of receiving of queries and returning search results need not be carried out at the same place, they can be distributed.
b) A web crawler 80 or crawlers to traverse the World Wide Web, loading web pages as it goes into a web mirror database, which is used for later indexing and analyzing. It controls which websites are revisited and how often, to enable changes in occurrences to be detected. This server can be arranged to maintain web collections which can represent portions of the web in the form of lists of URLs of pages or websites to be crawled. The crawlers are well known devices or software and so need not be described here in more detail
c) An index server 35 that builds a searchable index of all the web pages in the web mirror, stored in the index, this index containing relevancy ranking information to allow users to be sent relevancy-ranked lists of search results. This is usually indexed by ID of the content and by keywords contained in the content.
d) A server for the audio thumbnail generation and spoiling functions described above.

Web server programs are integral to the query server and the web crawler servers in some cases. These can be implemented to run Apache™ or some similar program, handling multiple simultaneous HTTP and FTP communication protocol sessions with users connecting over the Internet. The query server is connected to a database 70 that stores detailed device profile information on mobile devices and desktop devices, including information on the device screen size, device capabilities and in particular the capabilities of the browser or micro browser running on that device. The database may also store individual user profile information, so that the service can be personalised to individual user needs. This may or may not include usage history information. The search engine can be a system 103 as shown comprising the web crawler, the index server, the audio thumbnail generating and spoiling server, and the query server. It takes as its input a search query request from a user, and returns as an output a prioritised list of search results which can include several different types of results such as web pages and audio thumbnails for example. Relevancy rankings for these search results are calculated by the search engine by a number of alternative techniques as will be described in more detail.

Certain kinds of content e.g. web pages, can be ranked by existing techniques already known in the art, and multimedia content e.g. images, audio, or mobile specific pages, can be ranked differently for example. The type of ranking can be user selectable. For example users can be offered a choice of searching by conventional citation-based measures e.g. Google's™ PageRank™ or other measures.

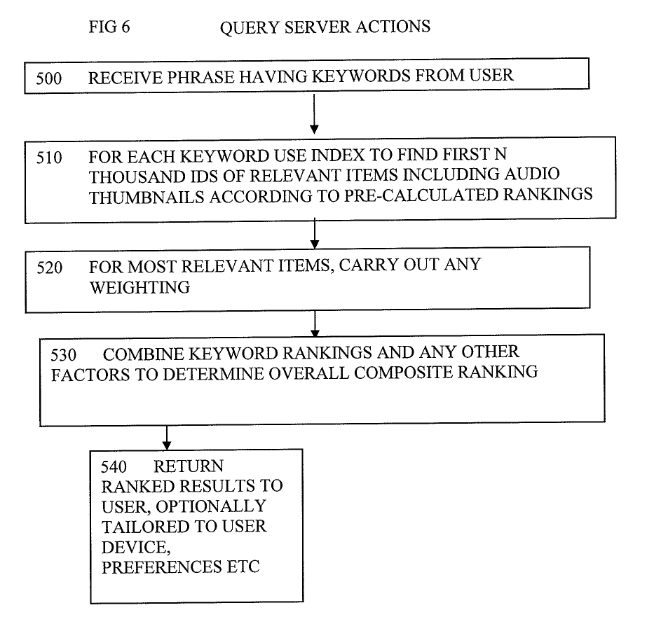

### Query Server Actions FIG. 6

Another embodiment of actions of a query server is shown in FIG. 6. In this example, a phrase having keywords is received from a user at step 500. At step 510, the query server uses an index to find the first n thousand IDs of content items relevant to keywords, in the form of audio thumbnails for example, according to pre-calculated rankings. At step 520, for the most relevant items, ranking scores are looked up and weighted as appropriate. At step 530, the query server uses keyword rankings, and any other factors to determine a composite ranking. The query server returns ranked results to the user, optionally tailored to user device, preferences etc at step 540, for example as a web page having a number of thumbnail images representing spoiled audio thumbnails.

The query server can be arranged to enable more advanced searches than keyword searches, to narrow the search by dates, by geographical location, by media type and so on. Also, the query server can present the results in graphical form to show mentions scores profiles for one or more content items. Another option can be to present indications of the confidence of the results, such as how frequently relevant websites have been revisited and how long since the results were crawled, or other statistical parameters.

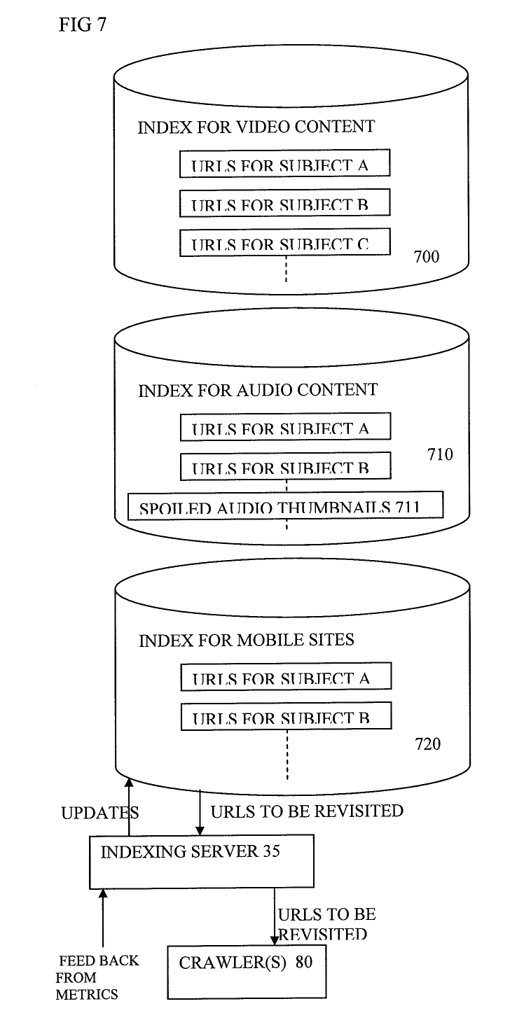

### Web Collections, FIG. 7

An additional feature of some embodiments is a web collections server arranged to determine which websites on the world wide web to revisit and at what frequency, to provide content items to the search engine. The web collections server can be arranged to determine selections of websites according to any one or more of: media type of the content items, subject category of the content items and the record of content items or mentions associated with the websites. The search results can comprise a list of content items, such as titles and URLs, or richer summaries of them, and an indication of rank of the listed content items in any form. This can help enable the search to return more relevant results.

FIG. 7 shows an example of indexes for different web collections. Three web collections are shown, there could be many more. A web collection for video content has a keyword index comprising lists of URLs of pages or preferably websites according to subject, in other words different categories of content, for example sport, pop music, shops and so on. A second web collection for audio content, likewise has a keyword index 710 comprising lists of URLs for different subjects, and comprising spoiled audio thumbnails 711. A third web collection for mobile sites again has an index 720 comprising lists of URLs for different subjects. The web collections are for use where there are so many content items that it is impractical to revisit all of them to update the index. Hence the web collections are a representative selection of popular or active websites which can be revisited more frequently, but large enough to enable changes to be monitored accurately. The indexes can be implemented as logically distinct indexes, with different rules for the information stored, but physically implemented as a single index.

The index server 35 can build and maintain the indexes of the web collections to keep them representative, and can control the timing of the revisiting. For different media types or categories of subject, there may be differing requirements for frequency of update, or of size of web collection. The frequency of revisiting can be adapted according to feedback such as which websites change frequently, or which rank highly by mentions score, or backlink rankings. The updates may be made manually. To control the revisiting, the indexing server feeds a stream of URLs to the web crawlers, and can rescan the crawled pages for changes in content items.

After a set period, the pages in a given web collection are rescanned to determine their changes, and keep the index up to date, at least for that web collection. The web collections are selected to be representative. Embodiments may have any combination of the various features discussed, to suit the application. A summary of the indexing operation for such an embodiment is as follows.

Step 1: determine a web collection of web sites to be monitored. This web collection should be large enough to provide a representative sample of sites containing the category of content to be monitored, yet small enough to be revisited on regular and frequent (e.g. daily) basis by a set of web crawlers.
Step 2: set web crawlers running against these sites, and create web mirror containing pages within all these sites.
Step 3: During each time period, scan files in web mirror, for each given web page identify file categories (e.g. audio midi, audio MP3, image JPG, image PNG) which are referenced within this page.
Step 4: For each category, apply the appropriate analyzer algorithm which reads the file, and identifies separate content items from the page.
Step 5: Index the content items.

### Other Features

In an alternative embodiment, the search is not of the entire web, but of a limited part of the web or a given database. In another alternative embodiment, the query server also acts as a metasearch engine, commissioning other search engines to contribute results (e.g. Google™, Yahoo™, MSN™) and consolidating the results from more than one source.

In an alternative embodiment, the web mirror is used to derive content summaries of the content items. These can be used to form the search results, to provide more useful results than lists of URLs or keywords. This is particularly useful for large content items such as video files. They can be stored along with the fingerprints, but as they have a different purpose to the keywords, in many cases they will not be the same. A content summary can encompass an aspect of a web page (from the world wide web or intranet or other online database of information for example) that can be distilled/extracted/resolved out of that web page as a discrete unit of useful information. It is called a summary because it is a truncated, abbreviated version of the original that is understandable to a user.

Example types of content summary include (but are not restricted to) the following
Web page text—where the content summary would be a contiguous stretch of the important, information-bearing text from a web page, with all graphics and navigation elements removed.
News stories, including web pages and news feeds such as RSS—where the content summary would be a text abstract from the original news item, plus a title, date and news source.
Images—where the content summary would be a small thumbnail representation of the original image, plus metadata such as the file name, creation date and web site where the image was found.
Ringtones—where the content summary would be a starting fragment of the ringtone audio file, plus metadata such as the name of the ringtone, format type, price, creation date and vendor site where the ringtone was found.
Video Clips—where the content summary would be a small collection (e.g. 4) of static images extracted from the video file, arranged as an animated sequence, plus metadata

The Web server can be a PC type computer or other conventional type capable of running any HTTP (Hyper-Text-Transfer-Protocol) compatible server software as is widely available. The Web server has a connection to the Internet 30. These systems can be implemented on a wide variety of hardware and software platforms.

The query server, and servers for indexing, calculating metrics and for crawling or metacrawling can be implemented using standard hardware. The hardware components of any server typically include: a central processing unit (CPU), an Input/Output (I/O) Controller, a system power and clock source; display driver; RAM; ROM; and a hard disk drive. A network interface provides connection to a computer network such as Ethernet, TCP/IP or other popular protocol network interfaces. The functionality may be embodied in software residing in computer-readable media (such as the hard drive, RAM, or ROM). A typical software hierarchy for the system can include a BIOS (Basic Input Output System) which is a set of low level computer hardware instructions, usually stored in ROM, for communications between an operating system, device driver(s) and hardware. Device drivers are hardware specific code used to communicate between the operating system and hardware peripherals. Applications are software applications written typically in C/C++, Java, assembler or equivalent which implement the desired functionality, running on top of and thus dependent on the operating system for interaction with other software code and hardware. The operating system loads after BIOS initializes, and controls and runs the hardware. Examples of operating systems include Linux™, Solaris™, UniX™, OSX™ Windows XP™ and equivalents.

1. A system for providing audio thumbnails of audio content items, the system having:
a thumbnail generator arranged to generate audio thumbnails representing corresponding ones of the audio content items;
a presentation part arranged to make the audio thumbnails available to a user to browse, and to enable the user to select a corresponding one of the audio content items, and
a spoiler arranged to spoil the audio thumbnails such that during audio presentation of a given thumbnail to a user, the audio presentation is spoiled but still provides a recognisable representation of the corresponding audio content item.

2. The system of claim 1, the spoiler being arranged to add an audible spoiling overlay.

3. The system of claim 2, the spoiling overlay comprising a voice-over.

4. The system of claim 1, the spoiler being arranged to add a spoiling prefix.

5. The system of claim 1, the spoiler being arranged to spoil dynamically in response to a request for the audio thumbnail from the user.

6. The system of claim 1, the presentation part being arranged to send a web page to a browser on a device of the user, the web page having hyperlinks to cause the audio presentations of the audio thumbnails when selected by a user.

7. The system of claim 6, the web page being a mobile web page, reasonably viewable on a screen of a hand held mobile device.

8. The system of claim 1, and comprising a search engine arranged to respond to a search query from the user, the presentation part being arranged to send search results comprising a number of the audio thumbnails relevant to the search query.

9. The system of claim 6, at least some of the items of audio content being online, and the web page having one or more hyperlinks to the online items as well as their corresponding audio thumbnail.

10. The system of claim 8, and having a web crawler arranged to crawl online items of audio content, the thumbnail generator being arranged to generate audio thumbnails from the crawled online items.

11. The system of claim 1, the thumbnail generator being arranged to pre generate a number of audio thumbnails and store them in a store of audio thumbnails.

12. A method of providing audio thumbnails of audio content items, the method having the steps of:
generating audio thumbnails representing corresponding ones of the audio content items;
making the audio thumbnails available to a user to browse, and to enable a user to select a corresponding one of the audio content items, and
spoiling the audio thumbnails such that during audio presentation of a given one of the audio thumbnails to a user, the audio presentation is spoiled but still provides a recognisable representation of the corresponding audio content item.

13. The method of claim 12, the spoiling involving adding an audible overlay.

14. The method of claim 12, the spoiling involving adding a prefix.

15. The method of claim 12, the making available involving sending a web page to a browser on a device of the user, the web page having hyperlinks to cause the audio presentations of the audio thumbnails when selected by a user.

16. The method of claim 15, the web page being a mobile web page, reasonably viewable on a screen of a hand held mobile device.

17. The method of claim 12, having the steps of responding to a search query from the user, the making available involving sending search results to the user comprising one or more audio thumbnails relevant to the search query.

18. A method of using a search service, the method having the steps of:
sending a search query, receiving search results comprising one or more spoiled audio thumbnails representing corresponding audio content items relevant to the search query, and browsing the audio content items by causing an audio presentation of one or more of the corresponding audio thumbnails, the audio presentations being spoiled but still providing a recognisable representation of their corresponding audio content items.

19. The method of claim 18, involving using a mobile device to receive the search results and browse the audio content items.

20. A computer program on a physical medium and arranged to be executable by computing hardware so as to provide audio thumbnails of audio content items, the program having:
a program part for use as a thumbnail generator to generate audio thumbnails representing corresponding ones of the audio content items;
a program part for use as a presentation part to make the audio thumbnails available to a user to browse, and to enable the user to select a corresponding one of the audio content items, and
a part for use as a spoiler to spoil the audio thumbnails such that during audio presentation of a given thumbnail to a user, the audio presentation is spoiled but still provides a recognisable representation of the corresponding audio content item.
